(19) United States
(12) Patent Application Publication
(10) Pub. No.: US 2022/0370840 A1
(43) Pub. Date: Nov. 24, 2022

(54) HARNESS ADAPTER SYSTEM LOAD BAR

(71) Applicant: Nelson O. Mc Kay, Santa Ana, CA (US)

(72) Inventor: Nelson O. Mc Kay, Santa Ana, CA (US)

(21) Appl. No.: 17/455,605

(22) Filed: Nov. 18, 2021

Related U.S. Application Data
(60) Provisional application No. 63/191,089, filed on May 20, 2021.

(51) Int. Cl. A62B 35/00

(52) U.S. Cl. CPC A62B 35/0018; A62B 35/0037; A62B 35/0068

(57) ABSTRACT

A load bar having a straight pipe body disposed between two opposite end sections, wherein the pipe body has a radial cross section; and two end loops, each end loop having a radial cross section and being disposed on a different end section of the load bar, wherein the radial cross sections of the two end loops are parallel with each other and perpendicular to the radial cross section of the pipe body. The load bar may be implemented within the harness adapter connector portion of a harness adapter system in order to prevent the compressive force from an attached load from being exerted on a secured lineman. Utilization of this load bar may increase the safe load limit while securing a lineman from 500 lbs. to 2000 lbs., effectively broadening the application for the harness adapter system. The load bar may also be used with lighter loads to prevent lineman discomfort.

### CROSS-REFERENCE TO RELATED APPLICATIONS

This application claims the benefit of U.S. Provisional Application No. 63/191,089, filed May 20, 2021, which is hereby incorporated by reference, to the extent that it is not conflicting with the present application.

### BACKGROUND OF INVENTION

### 1. Field of the Invention

The invention relates generally to safety equipment and specifically to load bars for use with a harness adapter system.

### 2. Description of the Related Art

The requirements of various applications that employ the use of a lineman suspended in a full body harness have necessitated recent advancements with regards to harness safety and functionality. The harness adapter system described in US patents U.S. Pat. Nos. 10,898,740B2 and 10,213,631B2 improves upon many of the issues present in previous safety harness technologies. These improvements include facilitating a more even weight distribution throughout the harness, reducing movement restrictions for a secured lineman and removing visual obstructions for said lineman. This harness adapter system (“HAS”) functions safely and effectively at weights up to the safety limit of 500 lbs., making it well suited for many different applications. However, there are applications that would benefit from the HAS that would require heavier loads to be carried, while preventing the weight of said loads from exerting their compressive force upon the attached lineman. Industries including construction, aviation, emergency management and many others may have a need for a lineman to be present while simultaneously carrying heavier loads with said lineman.

FIG. 1 and FIG. 2 described below are provided to provide a brief overview of pertinent portions of the harness adapter system, as well as aspects of the harness adapter system that may be improved upon.

FIG. 1 illustrates the front view of a three-point lineman harness adapter 134 attached to a harness adapter connector 125 for use within a HAS 123, according to an aspect. The harness adapter connector portion 125 (“harness adapter connector”) is secured to the three-point lineman harness adapter 134 by two carabiners 117. A lineman may be secured to the three-point lineman harness 134 by securing a lineman's harness (not shown) to loop 129. A load or additional lineman may be attached to the harness adapter connector portion 125 of the HAS 123 by the O-ring 113 disposed below loop 129. The three-point lineman harness adapter 134 may secure the attached harness adapter connector 125 to an above support point through the usage of a mounting carabiner 133 disposed at the top of the three-point lineman harness adapter 134.

FIG. 2 illustrates the front view of an upper lineman 235a and a lower lineman 235b attached in series using a HAS 223, according to an aspect. As can be seen by the two linemen in FIG. 2, the upper lineman 235a is experiencing some compression as a result of the weight of the lower lineman 235b. This compression may result in some discomfort for the upper lineman 235a when carrying weights (“loads”) above a certain threshold (e.g., 200 lbs.), even with loads below a safety limit of 500 lbs. As a result, implementation of a compression prevention device within a HAS 223, even when carrying weights below the safety limit, may be needed to prevent the discomfort of a lineman supported above a weight.

Therefore, there is a need to provide a device that enhances the functionalities of the HAS as described above.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description.

In an aspect, a load bar is provided, the load bar comprising: an outer pipe having: an outer pipe body with a cylindrical surface and a radial cross section disposed between a closed end section and an open end section; an outer pipe end loop having a radial cross section, said outer pipe end loop secured to the closed end section of the outer pipe; and a plurality of outer pipe hole pairs disposed within the outer pipe body, wherein each outer pipe hole of an outer pipe hole pair is coaxially aligned with the other outer pipe hole of said outer pipe hole pair and each outer pipe hole is orthogonal to the cylindrical surface of the outer pipe body; an inner pipe having: an inner pipe body with a cylindrical surface and a radial cross section disposed between a closed end section and an open end section; an inner pipe end loop having a radial cross section, secured to the closed end section of the inner pipe; and a plurality of inner pipe hole pairs disposed within the inner pipe body, wherein each inner pipe hole of an inner pipe hole pair is coaxially aligned with the other inner pipe hole of said inner pipe hole pair and each inner pipe hole is orthogonal to the cylindrical surface of the inner pipe body, wherein the inner pipe body is configured to nest within the outer pipe body, such that at least one outer pipe hole pair aligns coaxially with a corresponding inner pipe hole pair and wherein the radial cross section of the inner pipe end loop and the radial cross section of the outer pipe end loop are configured to be parallel with each other; and a locking pin having: a cross section shape configured to be inserted through an outer pipe hole pair and a corresponding coaxially aligned inner pipe hole pair to secure the inner pipe to the outer pipe, wherein the load bar is configured to be installed within a harness adapter system. Thus, an advantage is that the compressive force of a load carried by a HAS may be exerted upon the load bar, rather than the lineman. Another advantage is that the load bar may be adjusted for optimal sizing, based upon application needs and lineman characteristics. Another advantage is that the load bar increases the load weight limit while carrying a lineman in a HAS to 2,000 lbs., effectively broadening the potential applications of the HAS within many industries, including the flight and construction industry. Another advantage is that the load bar may be selectively installed and uninstalled from the HAS, allowing it to be implemented as needed. Another advantage is that the disclosed load bar is light weight, and thus will not notably increase the weight of the HAS, while still greatly improving is load weight limit.

In another aspect, a load bar is provided, the load bar comprising: a straight pipe body disposed between two opposite end sections, the straight pipe body having a radial cross section; and two end loops, each end loop having a radial cross section and being disposed on a different end section of the load bar, wherein the radial cross sections of the two end loops are parallel with each other and perpendicular to the radial cross section of the straight pipe body and wherein the load bar is configured to be installed within a harness adapter system. Again, an advantage is that the compressive force of a load carried by a HAS may be exerted upon the load bar, rather than the lineman. Another advantage is that the load bar increases the load weight limit while carrying a lineman in a HAS to 2,000 lbs., effectively broadening the potential applications of the HAS within many industries, including the flight and construction industry. Another advantage is that the load bar may be selectively installed and uninstalled from the HAS, allowing to be implemented as needed. Another advantage is that the disclosed load bar is light weight, and thus will not notably increase the weight of the HAS, while still greatly improving is load weight limit.

In another aspect, a load bar is provided, the load bar comprising: two end loops; and a pipe body associated with and disposed between the two end loops, wherein the load bar is configured to be installed within a harness adapter system and wherein a radial cross section of the pipe body is perpendicular with radial cross sections of the two end loops. Again, an advantage is that the compressive force of a load carried by a HAS may be exerted upon the load bar, rather than the lineman. Another advantage is that the load bar increases the load weight limit while carrying a lineman in a HAS to 2,000 lbs., effectively broadening the potential applications of the HAS within many industries, including the flight and construction industry. Another advantage is that the load bar may be selectively installed and uninstalled from the HAS, allowing to be implemented as needed. Another advantage is that the disclosed load bar is light weight, and thus will not notably increase the weight of the HAS, while still greatly improving is load weight limit.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates the front view of a three-point lineman harness adapter attached to a harness adapter connector for use within a HAS, according to an aspect.

FIG. 2 illustrates the front view of two linemen attached in series using a HAS, according to an aspect.

FIG. 3A illustrates a top view of a fixed length load bar for use within a HAS, according to an aspect.

FIG. 3B illustrates a top view of an adjustable length load bar for use within a HAS, according to an aspect.

FIG. 4 illustrates the front view of a fixed length load bar implemented within the harness adapter connector portion of a HAS, according to an aspect.

FIG. 5A illustrates the front view of a first lineman secured within a HAS, with said HAS utilizing a load bar, according to an aspect.

FIG. 5B illustrates the front view of a second lineman secured within a HAS, with said HAS utilizing a load bar, according to an aspect.

FIG. 5C illustrates the front view of a third lineman secured within a HAS, with said HAS utilizing a load bar, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

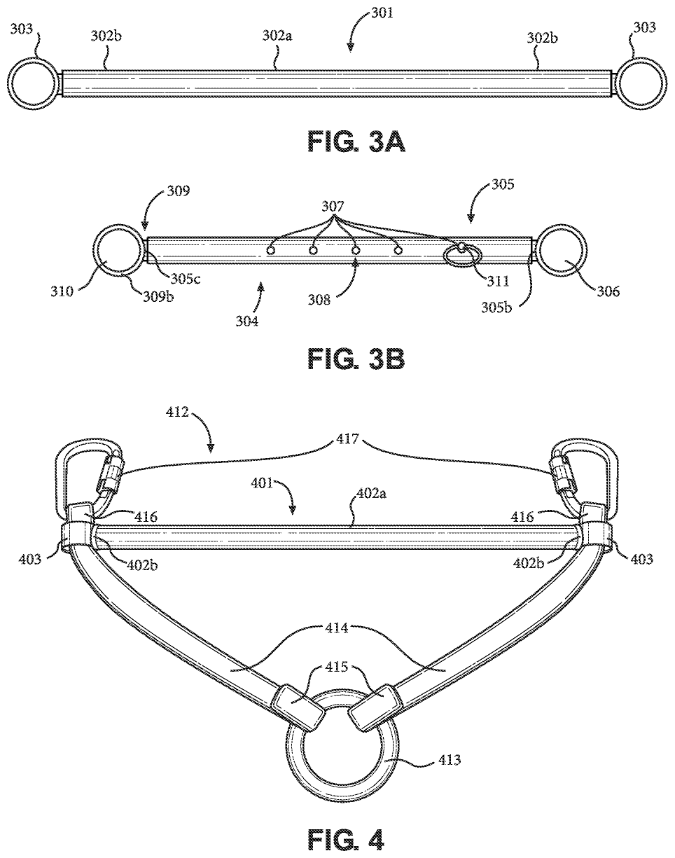

FIG. 3A illustrates a top view of a fixed length load bar 301 for use within a HAS, according to an aspect. FIG. 3B illustrates a top view of an adjustable length load bar 304 for use within a HAS, according to an aspect. The disclosed fixed length load bar 301 (“fixed load bar”) of FIG. 3A may be comprised of a pipe body 302a disposed between two opposite end sections 302b. The pipe body 302a may be a straight pipe having a radial cross section and a uniform wall thickness. An end loop 303 may be disposed on each opposite end section 302b, wherein each end loop 303 has a radial cross section. Said end loops 303 may be parallel with each other, such that the radial cross section of each end loop 303 is perpendicular with the radial cross section of the pipe body 302a. The fixed length load bar 301 may be comprised of a high strength and durable material, such as steel or another suitable metal. By providing the pipe body 302a as a hollow straight pipe, the fixed length load bar 301 may be made lightweight while still providing suitable compression resistance when installed within a HAS. The fixed length load bar 301 may also be formed as a singular, monolithic piece, through the usage of diecasting, or other suitable manufacturing methods. The radial cross section of the pipe, and the radial cross sections of each end loop may be circular, as depicted by fixed length load bar 301 of FIG. 3A. The potential for alternatively shaped pipe bodies 302a and end loops 303 is described hereinbelow.

One of ordinary skill in the art may choose to implement a plurality of comparable or equivalent variations to the above-described device and its elements. One may choose to vary the cross-sectional shape of the pipe body 302a, such that said pipe body 302a has a square or hexagonal cross-section, instead of a circular one. The straight pipe 302 may also have its wall thickness varied or may be solid, rather than hollow. Additionally, one may choose to alter the shape of the end loops 303, potentially utilizing end loops with square or hexagonal cross sections, instead of those with circular cross sections. The pipe body 302a and each end loop 303 may be described as having a radial cross section, regardless of their specific shape, such that circular, square, octagonal or other shaped cross sections are all referred to as radial cross sections. Such variations are included to act solely as examples and should not be considered a comprehensive listing of potential variations that exist within the scope of the disclosed load bars.

The disclosed adjustable length load bar 304 (“adjustable load bar”) of FIG. 3B may be comprised of two interconnected pipe units; an outer pipe 305 and an inner pipe 309, forming a telescopic structure, wherein the inner pipe 309 is partially nested within the outer pipe 305. The outer pipe 305 may be comprised of an outer pipe body 305a with a cylindrical surface and a radial cross section disposed between a closed end section 305b and an open end section 305c, wherein an outer pipe end loop 306 is secured to the corresponding closed end section 305b. A plurality of outer pipe hole 307 pairs may be disposed within the outer pipe body such that each outer pipe hole 307 of a pair of outer pipe holes is coaxial with the other outer pipe hole of said pair and each outer pipe hole 307 is orthogonal to the cylindrical surface of the outer pipe body. The inner pipe 309 may be comprised of an inner pipe body (not shown) with a cylindrical surface and a radial cross section disposed between a closed end section 309b and an open end section (not shown), wherein an inner pipe end loop 310 is secured to the corresponding closed end section 309b. A plurality of inner pipe hole pairs may (not shown) may be disposed within the inner pipe body such that each inner pipe hole of a pair of inner pipe holes is coaxial with the other inner pipe hole of said pair and orthogonal to the cylindrical surface of the inner pipe body.

The inner pipe 309 may have the same features and configuration as the outer pipe 304, with the exception of the diameter of the inner pipe body. The inner pipe body may have a smaller diameter than the outer pipe body 305a, wherein said inner pipe body is configured to nest within the outer pipe body 305a through the insertion of the open end section of inner pipe 309 through the open end section 305c of the outer pipe 305. Upon the nesting of the inner pipe within the outer pipe, each pair of outer pipe holes 307 may align coaxially with a pair of inner pipe holes to form a plurality of locking ports 308. Alternatively, only one pair of inner pipe holes may align coaxially with a pair of outer pipe holes 305, while still rendering the adjustable load bar 304 functional. As long as one pair of inner pipe holes aligns coaxially with a pair of outer pipe holes 307 to form one locking port 308, the inner pipe 309 may be secured to the outer pipe 305 using a locking pin 311. Upon the coaxial alignment of corresponding pairs of holes on the outer pipe 305 and the inner pipe 309, the corresponding radial cross sections of the outer pipe end loop 306 and the inner pipe end loop 310 may be parallel with each other, such that the radial cross section of each end loop is perpendicular with the radial cross section of the outer pipe body 305a. The radial cross section of each pipe body, open end section, closed end section and end loop may be circular, or modified accordingly, such that nesting of the inner pipe 309 within the outer pipe may be facilitated.

A locking pin 311 may be configured to be inserted through corresponding pairs of coaxially aligned holes in the outer pipe 305 and the inner pipe 309, in order to secure the inner pipe 309 to the outer pipe 305 and establish a fixed distance between the outer pipe end loop 306 and the inner pipe end loop 310. At least one pair of outer pipe holes 307 may be coaxially aligned with a pair of inner pipe holes in order to allow the locking pin 311 to secure the inner pipe 309 to the outer pipe 305. A set of coaxially arranged holes corresponding to a pair of outer pipe holes 307 that aligns coaxially with a pair of inner pipe holes may form a locking port 308 configured to accept an inserted locking pin 311 to secure the adjustable load bar 304 at a set length. Several different locking ports 308 may be available depending on the set length of the adjustable length load bar 304. Both end loops of an adjustable load bar 304 may be attached to their respective pipes by welding or other suitable methods. The pipe holes on both the inner pipe 309 and the outer pipe 305 may be circular as depicted in FIG. 3A. The locking pin 311 may have a circular cross section configured to be inserted into a formed circular locking port 308.

The adjustable nature of the hereinabove disclosed adjustable load bar 304 may be useful in a variety of situations. The adjustable load bar 304 is configured such its telescopic structure, having a smaller diameter inner pipe body configured to fit and slide within a larger diameter outer pipe body 305a, allows for modification of its length. The adjustable load bar 304 may have its length modified by removing the inserted locking pin, sliding the inner pipe 309 within the outer pipe 305 to a position corresponding to a desired length, in which at least one pair of outer pipe holes 307 is coaxially aligned with a corresponding pair of inner pipe holes, then reinserting the locking pin in a formed locking port 308. The minimum length of the adjustable load bar 304 may be established when each outer pipe hole pair aligns coaxially with a corresponding inner pipe hole pair, as seen by adjustable load bar 304 in FIG. 3. A maximum length of the adjustable load bar 304 may be established when only a singular outer pipe hole pair aligns coaxially with a singular inner pipe hole pair, said hole pairs corresponding to the hole pairs on each pipe that are furthest from their corresponding end loop.

Certain application may necessitate a shorter load bar, in order to enable a lineman secured within the HAS to access a narrow area. Other applications may require a longer load bar, in order to provide a secured lineman with more room to work. The lineman themselves may also require a different length of load bar, based on their size, in order to prevent their compression. Therefore, it may be helpful to install such an adjustable load bar 304 within a HAS, such that changes to said load bar's length may be made without replacing the installed adjustable load bar 304. The adjustable length load bar 304, much like the fixed length load bar 301, may be comprised of a high strength and durable material, such as steel or another suitable metal. By providing the outer pipe body 305a and the inner pipe body as a hollow pipes, the adjustable load bar 304 may be made lightweight while still providing suitable compression resistance to a HAS. Similarly to pipe body 302a of fixed load bar 301, the inner pipe body and the outer pipe body 305a may both be straight pipes. The inner pipe 309, outer pipe 305 and locking pin 311 may each be formed as a singular, monolithic piece, formed through diecasting or other suitable manufacturing methods, which are then combined as described above to create the adjustable load bar 304.

One of ordinary skill in the art may choose to implement a plurality of comparable or equivalent variations to the above-described device and its elements. For example, much like with the fixed length load bar 301, one may vary the cross-sectional shapes of the inner pipe body 309 and outer pipe body 305a to be square or hexagonal. The inner pipe body and outer pipe body 305a may also have their wall thicknesses varied and the inner pipe body 309 may be varied to be solid. Similarly, the shapes of outer pipe end loop 306 and the inner pipe end loop 310 may be altered to be square, hexagonal or any other suitable shape. Again, all described and potential shapes of the cross sections of the pipe bodies and end loops may be described as radial cross sections. The inner pipe holes and the outer pipe holes may be varied to different shapes, including squares and hexagons. Such variations would require the cross-sectional shape of the locking pin 311 to varied accordingly to allow for its insertion of the formed locking port 308. The number of holes present and their locations on each pipe may also be varied as needed. One in the art may also choose to implement alterations to the locking pin mechanism, such as implementing a spring-loaded locking pin assembly for easy adjustment of load bar length. As described previously, such variations are included to act solely as examples and should not be considered a comprehensive listing of potential variations that exist within the scope of the disclosed load bars. At its simplest, a load bar may be comprised of two end loops and a pipe body associated with and disposed between two end loops 303.

FIG. 4 illustrates the front view of a fixed length load bar 401 implemented within the harness adapter connector portion 412 of a HAS, according to an aspect. An O-ring 413 may be connected to two straps 414 by their corresponding bottom loops 415. Each strap 414 may then travel through a corresponding opposite end loop 403 of a fixed length load bar 401. A carabiner 417 may be attached to each strap 414 by a corresponding top loop 416 disposed at a top end of each strap 414, wherein said carabiners 417 are configured to secure the harness adapter connector portion to the upper portions of the HAS assembly. The carabiners 417 are suitably sized to prevent the end loops 403 of the load 401 bar from traveling around them, effectively securing the load bar 401 to the harness adapter connector portion 412. The O-ring 413 is also sufficiently large to prevent the end loops 403 from traveling over it.

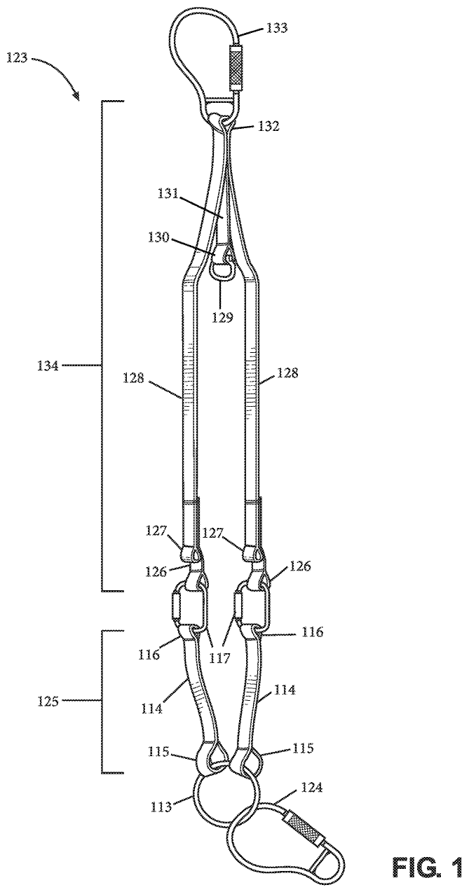

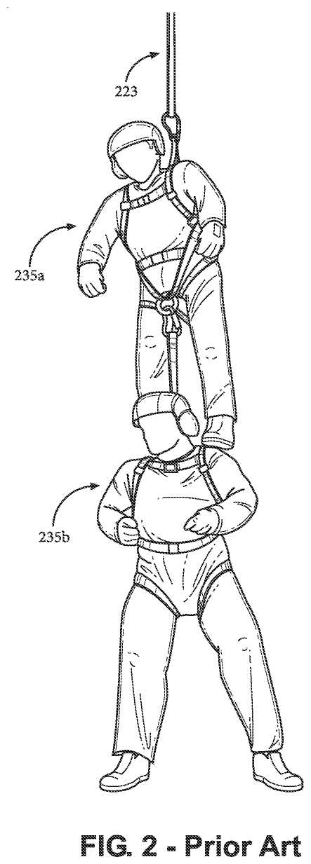

The implementation of a load bar within the harness adapter connector portion 412 of a HAS as described above, forces the carabiners 417 attached to the top loops 416 of the straps 414 to remain a distance apart, based on the length of the load bar 401. This distance may be fixed or adjustable, depending on the type of load bar used. In either case, this forced separation of the carabiners 417 prevents the compressive force that results from a load attached at the O-ring 413 from being exerted upon a lineman secured above said load in the HAS. This forced separation of the carabiners 417 allows for weights of up to 2000 lbs. to be carried on the O-ring 413 safely, without compressing the lineman. This improvement enables the HAS to be implemented in numerous applications, across a variety of industries, including the flight and construction industries, in which its enablement of superior weight capacity while supporting a linemen may be exploited. The harness adapter connector 412 of FIG. 4 may be the same as the harness adapter connector 125 of FIG. 1, with the exception of a load bar 401, included only in the former.

Additionally, the fixed length load bar 401 and the adjustable load bar, such as adjustable load bar 304 from FIG. 3, may be implemented reversibly within a HAS. Removal of the carabiners 417 attached to the top loops 416 of their respective straps 414 allows for corresponding end loops 403 of a load bar 401 to be threaded onto or removed from each strap. After the addition or removal of a load bar 401 to or from a HAS, reattaching each carabiner 417 to its respective top loop 416 returns the harness adapter connector portion 412 of a HAS to functional order. The simple installation and uninstallation of the above-described load bars affords the HAS system significant flexibility depending on the weight of a load, if present, and the desired application.

One of ordinary skill in the art may choose to implement a plurality of comparable or equivalent variations to the above-described arrangement and its elements. One in the art may choose to apply the load bar 401 to the straps 414 through comparable methods to the one described, including tying the straps 414 to the load bar end loops 403, after threading each strap 414 through its respective end loop and looping each strap 414 through its respective end loop 403 multiple times. Such variations are included to act solely as examples and should not be considered a comprehensive listing of potential variations that exist within the scope of the disclosed load bars.

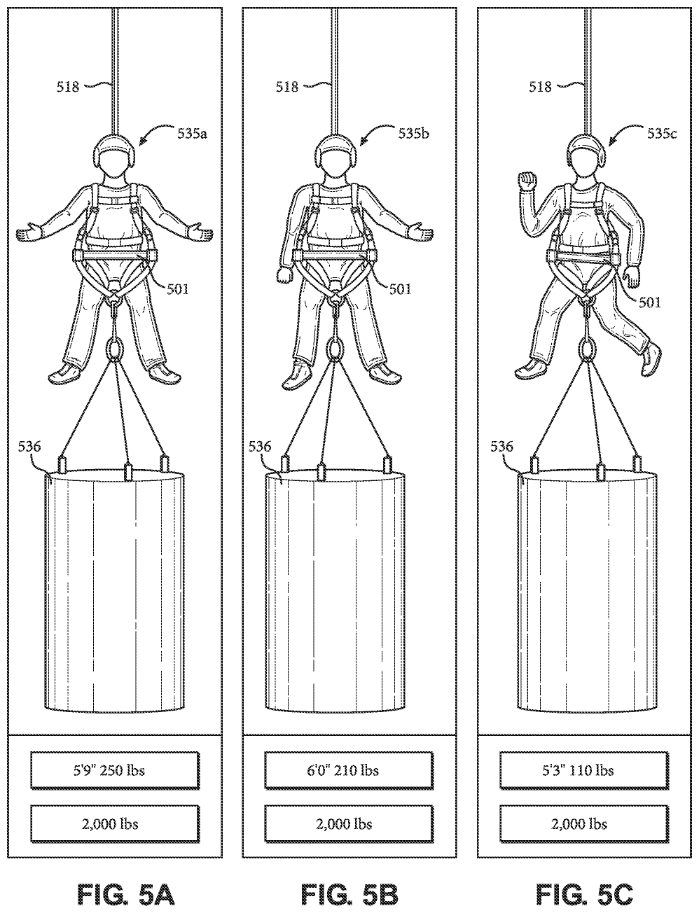

FIG. 5A illustrates the front view of a first lineman 535a secured within a HAS 518, with said HAS 518 utilizing a load bar 501, according to an aspect. FIG. 5B illustrates the front view of a second lineman 535b secured within a HAS 518, with said HAS 518 utilizing a load bar 501, according to an aspect. FIG. 5C illustrates the front view of a third lineman 535c secured within a HAS 518, with said HAS 518 utilizing a load bar 501, according to an aspect. The HAS 518 with a hereinabove described load bar 501 installed within is shown to be functionally capable of carrying a 2,000 lb. load 536 below a lineman without compressing them in three different examples in FIG. 5A-5C. FIG. 5A shows a first lineman 535a in a HAS 518 having an installed load bar 501, said first lineman 535a having a height and weight of 5′9″ and 250 lbs. respectively, and being carried with a 2,000 lb. load 536, without experiencing compression from said load 536. FIG. 5B shows a second lineman 535b in a HAS 518 having an installed load bar 501, said second lineman 535b having a height and weight of 6′0″ and 210 lbs. respectively, and being carried with a 2,000 lb. load 536, without experiencing compression from said load 535. FIG. 5C shows a third lineman 535c in a HAS 518 having an installed load bar 501, said third lineman 535c having a height and weight of 5′3″ and 110 lbs. respectively, and being carried with a 2000 lb. load 536, without experiencing compression from said load 536. These three examples display load bar 501 functionality over a variety of lineman 535 heights and weights at the working load limit of the HAS. This versatility allows a variety of linemen using the HAS to perform their required tasks without being compressed, regardless of their weight or height. While the load bar 501 may not be needed when lifting a load weighing less than 500 lbs., a load bar may still be implemented in order to prevent potential discomfort that a lineman may experience, even at lower weights.

The utilization of either a fixed length load bar, such as fixed load bar 301 of FIG. 3A, or an adjustable length load bar, such as adjustable load bar 304 of FIG. 3B, within a HAS 318 may allow for greater weights to be carried with a lineman within said HAS 518. By preventing the compressive force of a load supported below a held lineman from being exerted on said lineman, the lineman may be able to perform their task as if no load were below them at all. This increased load capacity for a HAS 518 while supporting a lineman may expand the applications of the HAS 518 to fields in which the simultaneous carrying of a lineman and a load may be necessary, such as construction, aviation and emergency services. The usage of an adjustable load bar 304 may allow an optimal load bar length to be established based upon the size of the lineman and the application.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases.

Throughout this description, the aspects, embodiments or examples shown should be considered as exemplars, rather than limitations on the apparatus or procedures disclosed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples.

What is claimed is:

1. A load bar comprising:
an outer pipe having:
an outer pipe body with a cylindrical surface and a radial cross section disposed between a closed end section and an open end section;
an outer pipe end loop having a radial cross section, said outer pipe end loop secured to the closed end section of the outer pipe; and
a plurality of outer pipe hole pairs disposed within the outer pipe body, wherein each outer pipe hole of an outer pipe hole pair is coaxially aligned with the other outer pipe hole of said outer pipe hole pair and each outer pipe hole is orthogonal to the cylindrical surface of the outer pipe body;
an inner pipe having:
an inner pipe body with a cylindrical surface and a radial cross section disposed between a closed end section and an open end section;
an inner pipe end loop having a radial cross section, secured to the closed end section of the inner pipe; and
a plurality of inner pipe hole pairs disposed within the inner pipe body, wherein each inner pipe hole of an inner pipe hole pair is coaxially aligned with the other inner pipe hole of said inner pipe hole pair and each inner pipe hole is orthogonal to the cylindrical surface of the inner pipe body,
wherein the inner pipe body is configured to nest within the outer pipe body, such that at least one outer pipe hole pair aligns coaxially with a corresponding inner pipe hole pair and wherein the radial cross section of the inner pipe end loop and the radial cross section of the outer pipe end loop are configured to be parallel with each other; and
a locking pin having:
a cross section shape configured to be inserted through an outer pipe hole pair and a corresponding coaxially aligned inner pipe hole pair to secure the inner pipe to the outer pipe,
wherein the load bar is configured to be installed within a harness adapter system.

2. The load bar of claim 1, wherein each inner pipe hole of the plurality of inner pipe hole pairs and each outer pipe hole of the plurality of outer pipe hole pairs has a circular shape.

3. The load bar of claim 2, wherein the locking pin has a circle shaped cross section.

4. The load bar of claim 1, wherein the length of the load bar may be established through the insertion of the locking pin through a pair of inner pipe holes and a coaxially aligned pair of outer pipe holes.

5. The load bar of claim 1, wherein the radial cross sections of the inner pipe end loop and the outer pipe end loop are perpendicular with the radial cross section of the of the outer pipe body.

6. A load bar comprising:
a straight pipe body disposed between two opposite end sections, the straight pipe body having a radial cross section; and
two end loops, each end loop having a radial cross section and being disposed on a different end section of the load bar,
wherein the radial cross sections of the two end loops are parallel with each other and perpendicular to the radial cross section of the straight pipe body and
wherein the load bar is configured to be installed within a harness adapter system.

7. The load bar of claim 6, wherein the load bar is configured to separate carabiners disposed on a harness adapter connector portion of a harness adapter system by a fixed distance.

8. The load bar of claim 7, wherein the separation of the carabiners by a fixed distance prevents a compressive force of a load held by the harness adapter system from being exerted on a lineman positioned between said carabiners.

9. The load bar of claim 6, wherein the load bar is formed as a singular, monolithic piece.

10. A load bar comprising:
two end loops; and
a pipe body associated with and disposed between the two end loops,
wherein the load bar is configured to be installed within a harness adapter system and
wherein a radial cross section of the pipe body is perpendicular with radial cross sections of the two end loops.

11. The load bar of claim 10, wherein said load bar is configured to be installed within a harness adapter connector portion of a harness adapter system.

12. The load bar of claim 11, wherein installation of the load bar is configured to prevent a supported load from compressing a lineman secured above said load.

13. The load bar of claim 10, wherein the load bar is utilized in applications in which a held load below a lineman exceeds a safety limit of 500 lbs.

14. The load bar of claim 10, wherein the load bar is configured to allow a harness adapter system to safely support a lineman while carrying a load of up to 2,000 lbs.

15. The load bar of claim 10, wherein the pipe body has a circular cross section.

16. The load bar of claim 10, wherein each end loop has a circular cross section.

17. The load bar of claim 10, wherein said load bar is made of steel.

18. The load bar of claim 10, wherein the pipe body is comprised of an inner pipe body nested within an outer pipe body, wherein one end loop is secured to the inner pipe body and the other end loop is secured to the outer piper body, and wherein coaxially aligned hole pairs disposed within the inner pipe body and the outer pipe body are configured to accept a locking pin to secure the inner pipe body to the outer pipe body.
